(19) United States
(12) Patent Application Publication
(10) Pub. No.: US 2024/0005367 A1
(43) Pub. Date: Jan. 4, 2024

(54) ATTRIBUTING AN IDENTITY TO A USER WHO SUBMITTED FEEDBACK

(71) Applicant: BirdEye, Inc., Palo Alto, CA (US)

(72) Inventors: Neeraj GUPTA, Sunnyvale, CA (US); Abhijeet SRIVASTAVA, Mountain View, CA (US)

(21) Appl. No.: 17/854,453

(22) Filed: Jun. 30, 2022

(51) Int. Cl. G06Q 30/02; G06F 40/30; G06F 40/284

(52) U.S. Cl. CPC G06Q 30/0282; G06F 40/30; G06F 40/284

(57) ABSTRACT

Techniques for determining an identity of a user who submitted third-party feedback are disclosed. Third-party feedback is identified at a third-party's platform. Information about the feedback is obtained. An attempt to identify the user's identity is performed using this information. In some cases, the attempt is based on tokens that are attributed based on spelling or perhaps based on sounds. In some cases, the attempt is based on the user's email address or a time as to when the user submitted the feedback. In some cases, the attempt may even be based on image data.

### BACKGROUND

In today's online marketplace, customers often leave feedback indicating the experience they had with a business. This feedback can be left on the business's own website or perhaps on a third-party website.

Often, the customers do not provide enough information for the business to immediately determine why the customer may have left a 5-star rating or why they left a 1-star rating. Having such information, however, is particularly beneficial from the business's perspective because feedback is one mechanism by which the business can improve the services or products it provides. Furthermore, knowing the identity of the user who left the feedback is desirable as well because businesses may want to try to rehabilitate a soured relationship or may want to try to have a satisfied customer be an advocate for the business. What is needed, therefore, is a technique for deducing or deriving the identity of a user who submitted feedback.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The embodiments disclosed herein relate to systems, devices, and methods for determining an identity of a reviewer who left feedback. As used herein, the terms “reviewer” and “user” can be interchanged with one another. As also used herein, the identity of a reviewer is usually not immediately known whereas the identity of a “customer” is known.

Some embodiments use fuzzy logic to determine an identity of a user who provided structured and/or unstructured third-party feedback, where the third-party feedback is feedback that was provided to a third-party computing entity that is distinct relative to a SAAS cloud platform. The embodiments maintain a list of websites for third-party computing entities that are distinct relative to the SAAS cloud platform. The embodiments query a first website that is included in the list. The query is designed to extract third-party feedback that a user provided to the first website, and the third-party feedback is directed toward an entity with whom the user previously engaged. A result is received as a consequence of executing the query. The result includes the third-party feedback, which was extracted from content hosted by the first website. The embodiments identify, from the result, a name associated with the third-party feedback. The embodiments parse the name into parts and attribute a respective spelling-based token to each part. In response to determining that a first threshold level of match does not exist between the spelling-based tokens associated with the name and other spelling-based tokens associated with customer names managed by the SAAS cloud platform, the embodiments encode the name based on a phonetic algorithm to generate a set of sound-based tokens for the name. The set of sound-based tokens for the name is compared against other sound-based tokens that were generated for other names of customers managed by the SAAS cloud platform. The embodiments determine that a second threshold level of match does exist between the set of sound-based tokens for the name and a particular set of sound-based tokens included among those other sound-based tokens. Based on the match and based on user information managed by the SAAS cloud platform, an identity is determined for the user who left the third-party feedback.

Some embodiments maintain a list of websites for third-party computing entities that are distinct relative to the SAAS cloud platform. The embodiments query a first website and receive a result. A name is identified based on the result. The embodiments parse the name into at least a first name portion and a last name portion. Either one of the first name portion or the last name portion is a partial name as opposed to a full name. In response to determining that a first threshold level of match does not exist between a combination of the first name portion and the last name portion and combinations of other first names and last names managed by the SAAS cloud platform, the embodiments tokenize the first name portion and the last name portion to generate a first set of tokens. The embodiments compare the first set of tokens against name-aliases that are managed by the SAAS cloud platform. The embodiments determine that a second threshold level of match does exist between the first set of tokens and a particular alias that is managed by the SAAS cloud platform. The embodiments associate one of the first name portion or the last name portion with the particular alias. Based on the match and based on user information managed by the SAAS cloud platform, an identity is determined for the user who left the third-party feedback.

Some embodiments maintain a list of websites and query a first website. The embodiments receive a result as a consequence of executing the query. The embodiments identify, from the result, an email address associated with the third-party feedback. The email address is parsed into parts, and the embodiments attribute a respective token to each part. The embodiments compare the tokens associated with the email address against other tokens that were generated for customer names that are managed by the SAAS cloud platform. The embodiments determine that a threshold level of match does exist between the tokens associated with the email address and a particular set of tokens included in among the other tokens. Based on the match and based on user information managed by the SAAS cloud platform, the embodiments determine an identity for the user who left the third-party feedback.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture designed to determine an identity of a user who provided first-party feedback.

FIG. 2 illustrates various examples of feedback.

FIG. 3 illustrates an example architecture, which can be an expanded version of the architecture from FIG. 1 and which is designed to determine an identity of a user who provided third-party feedback.

FIG. 4 illustrates how the architecture can analyze structured and/or unstructured feedback.

FIGS. 5A and 5B illustrate various different techniques for determining the identity of a user who provided feedback.

FIG. 6 illustrates an initial flowchart of a method for querying a website to obtain feedback data.

FIG. 7 illustrates a flowchart of a method for analyzing the feedback data to determine whether the identity can be determined using spelling-based tokens or sound-based tokens.

FIG. 8 illustrates a flowchart of a method for analyzing the feedback data to determine whether the identity can be determined using name portions included in the feedback data or using alias information.

FIG. 9 illustrates a flowchart of a method for analyzing the feedback data to determine whether the identity can be determined using email information.

FIG. 10 illustrates an example flowchart for determining the identity of a user who provided feedback.

FIG. 11 illustrates an example computer system that is configured to perform any of the disclosed operations.

### DETAILED DESCRIPTION

The embodiments disclosed herein relate to systems, devices, and methods for determining an identity of a reviewer who left feedback. As used herein, the terms “reviewer” and “user” can be interchanged with one another. As also used herein, the identity of a “reviewer” is usually not immediately known whereas the identity of a “customer” is known.

Some embodiments use fuzzy logic to determine an identity of a user. The embodiments maintain a list of websites for third-party computing entities. The embodiments query a first website. The query is designed to extract third-party feedback that a user provided to the first website. The embodiments receive the third-party feedback based on the query. The embodiments identify a name associated with the third-party feedback. The name is parsed into multiple parts, and a respective spelling-based token is attributed to each part. In response to determining that a first threshold level of match does not exist between the spelling-based tokens associated with the name and other spelling-based tokens associated with other customer names, the embodiments encode the name based on a phonetic algorithm to generate a set of sound-based tokens. The sound-based tokens are compared against other sound-based tokens that were generated for the other customer names. The embodiments determine that a second threshold level of match does exist between the name's sound-based tokens and a particular set of sound-based tokens. An identity is then determined for the user who left the third-party feedback.

Some embodiments parse the name into at least a first name portion and a last name portion. Either one of the first name portion or the last name portion is a partial name as opposed to a full name. In response to determining that a first threshold level of match does not exist between a combination of the first and last name portions and combinations of other first and last names, the embodiments tokenize the first name portion and the last name portion to generate a first set of tokens. The embodiments compare the first set of tokens against name-aliases that are managed by the SAAS cloud platform. The embodiments determine that a second threshold level of match does exist between the first set of tokens and a particular alias. The embodiments associate one of the first name portion or the last name portion with the particular alias. An identity is then determined for the user who left the third-party feedback.

Some embodiments identify an email address associated with the third-party feedback. The email address is parsed into multiple parts, and the embodiments attribute a respective token to each part. The embodiments compare the email tokens against other tokens that were generated for customer names. The embodiments determine that a threshold level of match does exist between the tokens associated with the email address and a particular set of tokens. The embodiments then determine an identity for the user who left the third-party feedback.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

Today, businesses often communicate with reviewers publicly via a social media platform. This disclosed embodiments provide businesses the flexibility to engage with reviewers publicly over social media or privately by attributing the review with a customer contact and then allowing businesses to connect with them directly over email, text, or any other communication mechanism. This will help businesses identify which customers are unhappy or satisfied. If satisfied, the customers may potentially become ambassadors for the business's brand. If a customer is not satisfied, the business can attempt to rehabilitate the relationship.

The disclosed embodiments provide substantial benefits, improvements, and practical applications to the technical field of data analysis. It is often the case that users who engage with a business leave feedback or a review of that business on a third-party website, such as perhaps a Google review. Sometimes, the name of the person who left the review is partially obfuscated or otherwise privatized. It is highly desirable for businesses to obtain this feedback so they can improve their customer service. If the user had a negative experience, it is beneficial for the business to learn of the user's identity so a business representative can try to rehabilitate the relationship with the user. If the user had a positive experience, it is beneficial for the business representative to reach out to the user to see if the user would be willing to be an advocate for the business, such as perhaps by referring the business to the user's acquaintances. As a result, determining the identity of the user is highly desirable.

The disclosed embodiments provide various techniques for determining the identity of the user so the above-described benefits can be accomplished. By doing so, the disclosed embodiments significantly improve the ability for a business to reach out to a user in order to improve the business-client relationship.

The embodiments also improve how structured and/or unstructured data is analyzed. In doing so, the operations of the computer are also improved because the disclosed analysis techniques provide for more efficient and robust data analysis processes. Some of the embodiments can further utilize machine learning to help with the analysis process. As will be described in more detail later, the embodiments are able to train a machine learning (ML) engine to identify an identity of the user. After the ML engine is trained, the ML engine can be used to facilitate the various processes of determining a user's identity.

The embodiments also improve or enhance computer security. For instance, the disclosed principles can be employed to determine whether bot accounts are being used to spam or otherwise spread false information regarding a business. The embodiments can perform various investigative operations to determine whether an entity that is leaving feedback is an actual human or, instead, is a bot account. If it is a bot account, the embodiments can improve computer security and even computing efficiency by triggering a removal of the bot account and/or by sending an alert regarding the presence of the bot account. In some cases, the embodiments can even flag an account associated with the bot so that others may know of the bot. Identifying a bot is highly beneficial and provides numerous advantages because it improves computer security and can also improve computing efficiency. Instead of expending resources to host feedback provided by a bot, hosting platforms can be informed of the bot and can delete their content. By deleting this content, the host platform's computing operations will be improved. As such, the disclosed embodiments not only improve computer security but also improve computing operations and efficiency. Accordingly, these and numerous other benefits will now be described in more detail throughout the remaining portions of the disclosure.

### Example Architecture for Acquiring First-Party Feedback

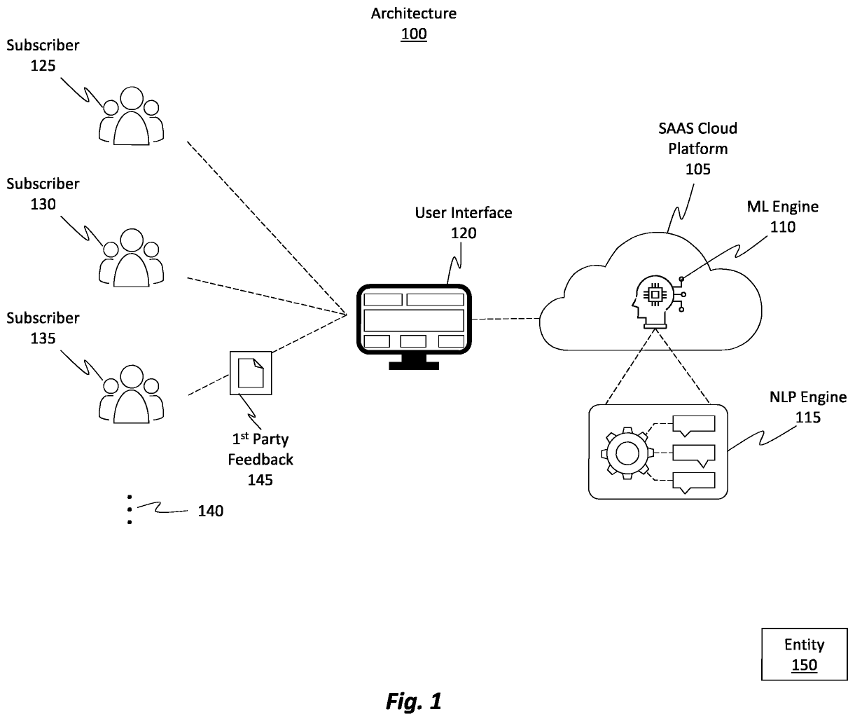

Attention will now be directed to FIG. 1, which illustrates an example architecture 100 that can be used to provide the benefits mentioned above. Architecture 100 is shown as including a software as a service (SAAS) cloud platform 105. In some embodiments, this SAAS cloud platform 105 includes a machine learning (ML) engine 110 that can optionally include a natural language processing (NLP) engine 115.

As used herein, reference to any type of machine learning may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The SAAS cloud platform 105 can provide a user interface 120 for any number of subscribers (aka “customers”) to view and interact with. The subscribers, such as subscribers 125, 130, and 135 (the ellipsis 140 shows how any number of subscribers may be present) are subscribed with the SAAS cloud platform 105 and can provide first-party feedback 145 directly to the SAAS cloud platform 105. This first-party feedback 145 can be feedback regarding an interaction the subscriber had with an entity 150, such as a business online entity.

Inasmuch as the subscribers are providing the feedback directly to the SAAS cloud platform 105, this type of feedback is referred to as “first-party” feedback. If users were to submit feedback to an external entity relative to the SAAS cloud platform 105 (e.g., perhaps a Google review), then that type of feedback is referred to as “third-party” feedback.

In the scenario presented in FIG. 1, the identities of the subscribers are known to the SAAS cloud platform 105 because the subscribers were previously known to the SAAS cloud platform 105. For instance, the subscribers may have an account with the SAAS cloud platform 105. Therefore, when the first-party feedback 145 is received, the SAAS cloud platform 105 can immediately determine the identity of the subscriber who submitted the first-party feedback 145. As will be described in more detail later, the identity of a user (i.e. not necessarily a subscriber/customer) who submitted feedback may not be initially available in the case of third-party feedback.

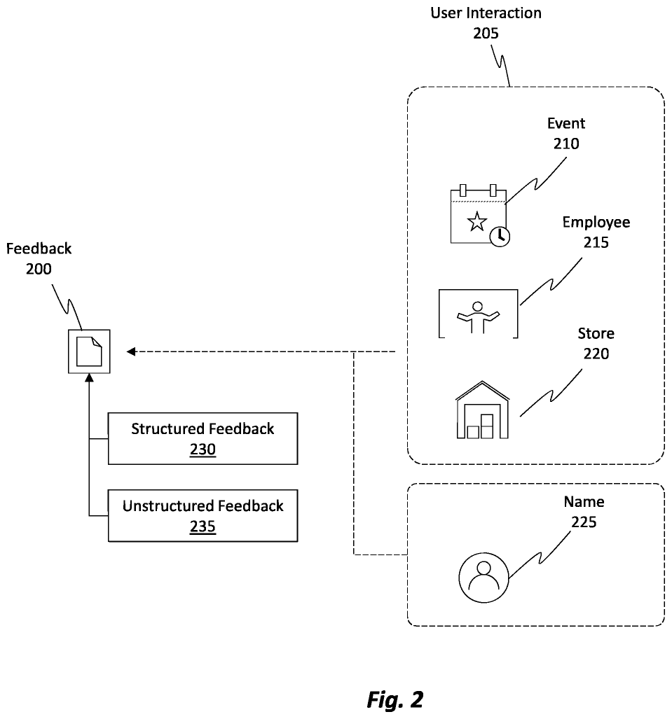

As far as characteristics or attributes of the feedback (regardless of whether it is first-party or third-party), FIG. 2 provides some additional information. FIG. 2 shows feedback 200, which can be representative of the first-party feedback 145 from FIG. 1 or any type of third-party feedback.

The feedback 200 is provided by a user who engaged with a business entity in some kind of user interaction 205. As shown, the user interaction 205 can be for a particular event 210, with a particular employee 215, or even at a particular store 220.

As used herein, the event 210 refers to any scenario in which a user interacted or engaged with a business entity in some manner. Such events can include a scenario where a user purchased an item, interacted with a website, or perhaps even perused a brick and mortar store.

A user interaction with an employee 215 includes any scenario where a user interacted with one of the employees of the business. This interaction can be an online interaction, a phone conversation, or perhaps even an in-person interaction.

A user interaction with the store 220 includes any scenario where a user interacted with the business's store. This interaction can be an online interaction, such as by navigating a website of the business. The interaction can also include an in-person physical interaction with the brick and mortar store.

Any other type of interaction can be included in the user interaction 205, without limit. The user can provide feedback 200 detailing any type of interaction the user may have had. As an example, event-based feedback can describe an event where the user interacted with the business's website, and the user had a positive, neutral, or perhaps a negative experience with the website. Employee-based feedback can describe whether the user had a positive, neutral, or negative experience with a particular employee. The store-based feedback can describe whether the user had a positive, neutral, or negative experience with the business's store. Indeed, any type of review or feedback can be provided by a user.

When the feedback is received via an online platform (e.g., perhaps the user left a Google review), then it is often the case that the feedback is associated with a name 225 of the user. In some cases, the feedback is associated with the actual name of the user. In some cases, the feedback is associated with an email address of the user. In some cases, a partial name of the user is provided. In some cases, other identity-related information may be associated with the feedback. Sometimes, supplemental information can also be provided with the feedback, such as the time when the feedback was provided, the location of the user when the user submitted the feedback, and so on.

The feedback 200 can be structured feedback 230 and/or unstructured feedback 235. In some cases, the feedback can be a combination of both structured feedback 230 and unstructured feedback 235.

By “structured” feedback, it is meant that the feedback is associated with a quantitative score of some kind. For instance, the structured feedback can include a star based rating, where the user can give 1 to 5 stars to the business. In some cases, the structured feedback can include a grade based rating, where the user can optionally give an “A” grade, “B” grade, “C” grade, “D” grade, or perhaps even an “F” grade. Any other quantitative based rating can be used.

By “unstructured” feedback, it is meant that the feedback is not associated with a quantitative score. For instance, the feedback may include text describing the user's experience, and the text can include sentiment data that does not initially have a value associated with it. As an example, the user review/feedback may state something like the following: “the product was amazing” or perhaps something like: “this product is the worst.” These phrases can reflect a sentiment the user has with regard to the business or to the good or service the business provides. In their current forms, however, these phrases do not have a value or rating associated with them.

The disclosed embodiments are able to use the NLP engine 115 from FIG. 1 to analyze unstructured feedback and provide structure to that feedback. The NLP engine 115 can extract sentiment information from the feedback and determine whether the feedback is generally positive in nature, neutral in nature, or negative in nature. Based on the analysis, a quantitative score can be attributed to the unstructured feedback, thereby providing some structure to the previously unstructured feedback.

The NLP engine 115 and/or the ML engine 110 can be trained using any amount of training data, which may include both structured and unstructured feedback. The training can be a supervised process or a partially supervised process. During the training, the ML engine can be informed as to what constitutes generally positive feedback, generally neutral feedback, and generally negative feedback. The ML engine can also be trained to impose a score to the unstructured feedback so as to provide structure to that feedback.

The disclosed embodiments are beneficially designed to determine an identity of a user who submitted feedback. By doing so, the embodiments can provide that identity to a business to enable the business to reach out to that user. If the user had a generally positive experience with the business, then the business can request the user to become an advocate for the business. If the user had a generally negative experience, then the business can attempt to rehabilitate the relationship.

Within the context of FIG. 1, the subscribers 125, 130, and 135 are generally known to the SAAS cloud platform 105, so their identities are already known as well. If the subscribers provide positive, neutral, or negative feedback, then the SAAS cloud platform 105 can provide those subscribers' identities to the business entity 150.

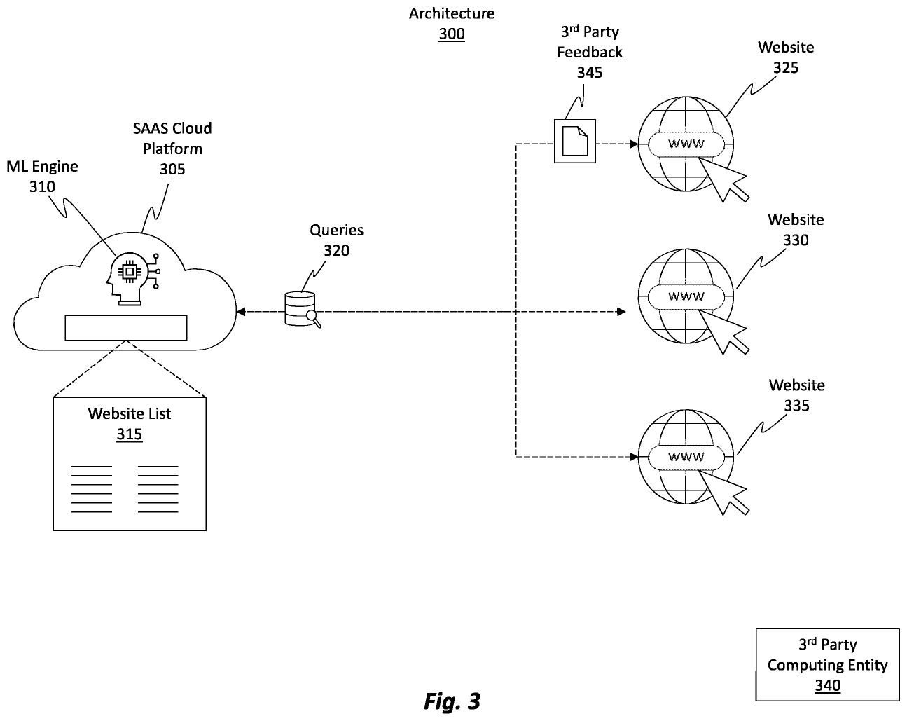

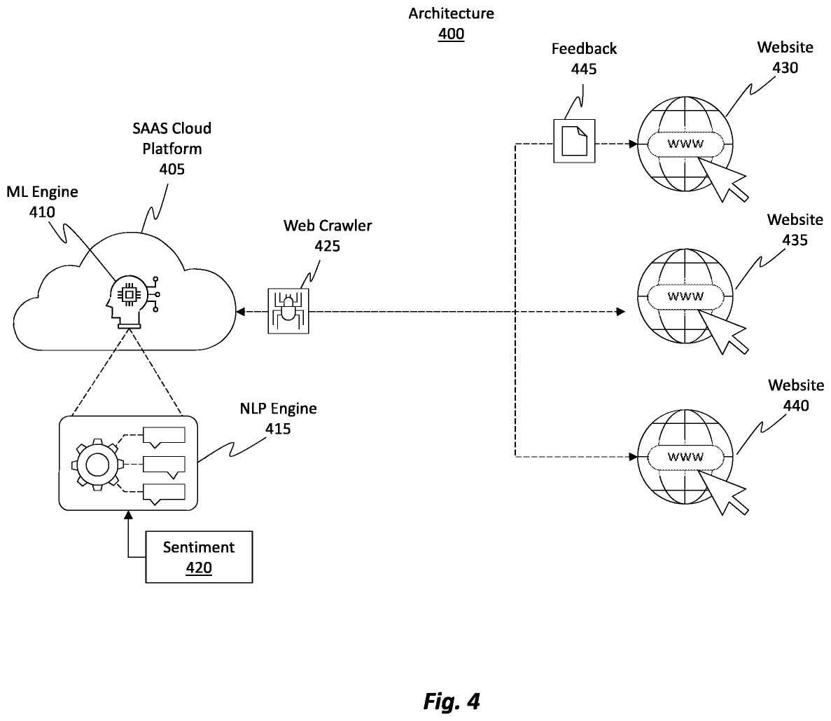

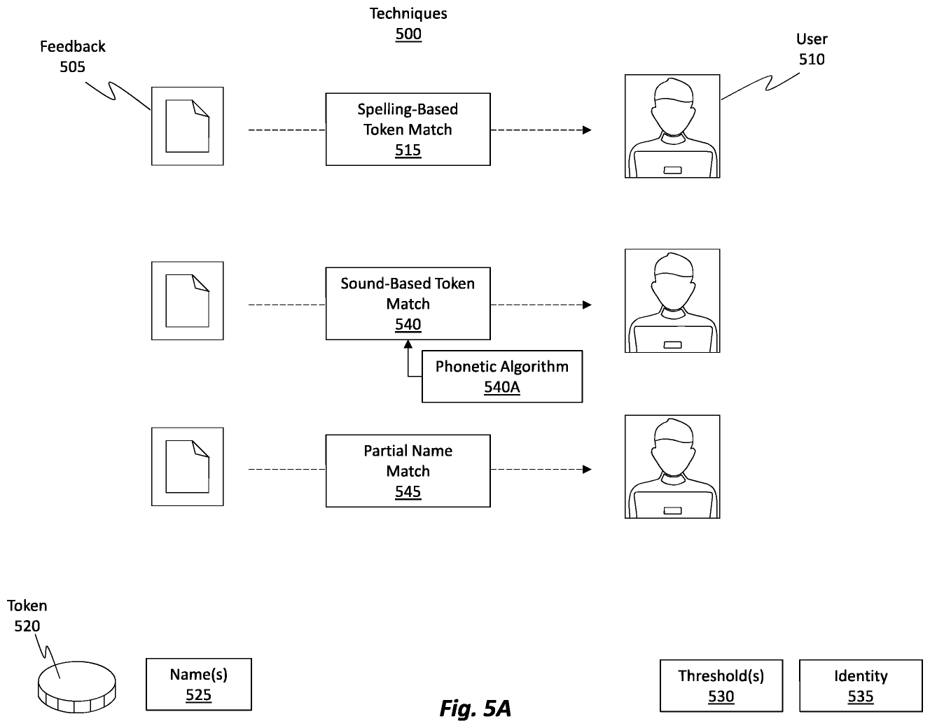

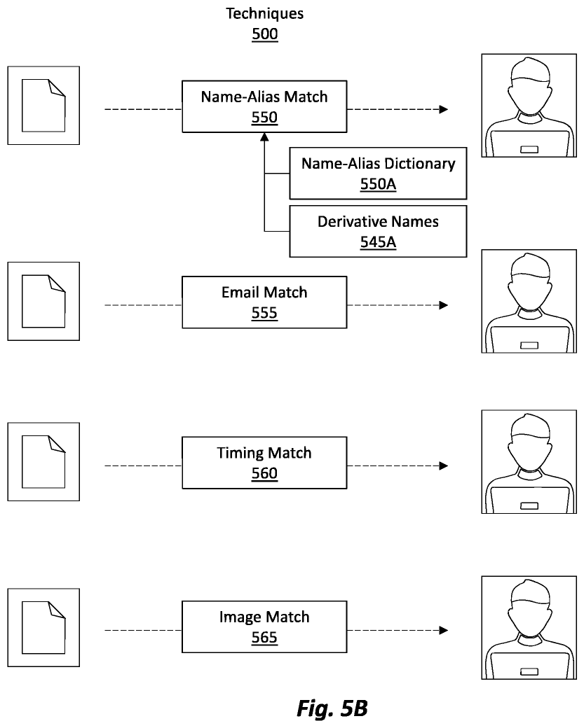

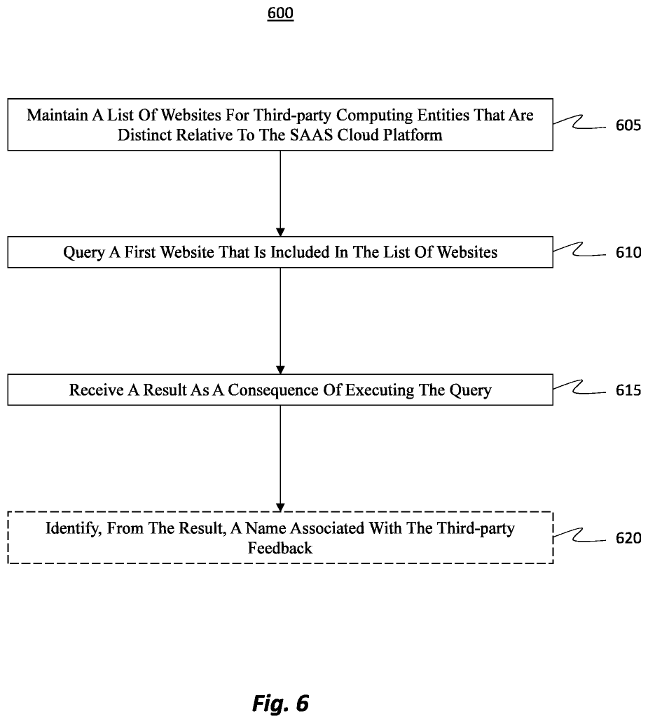

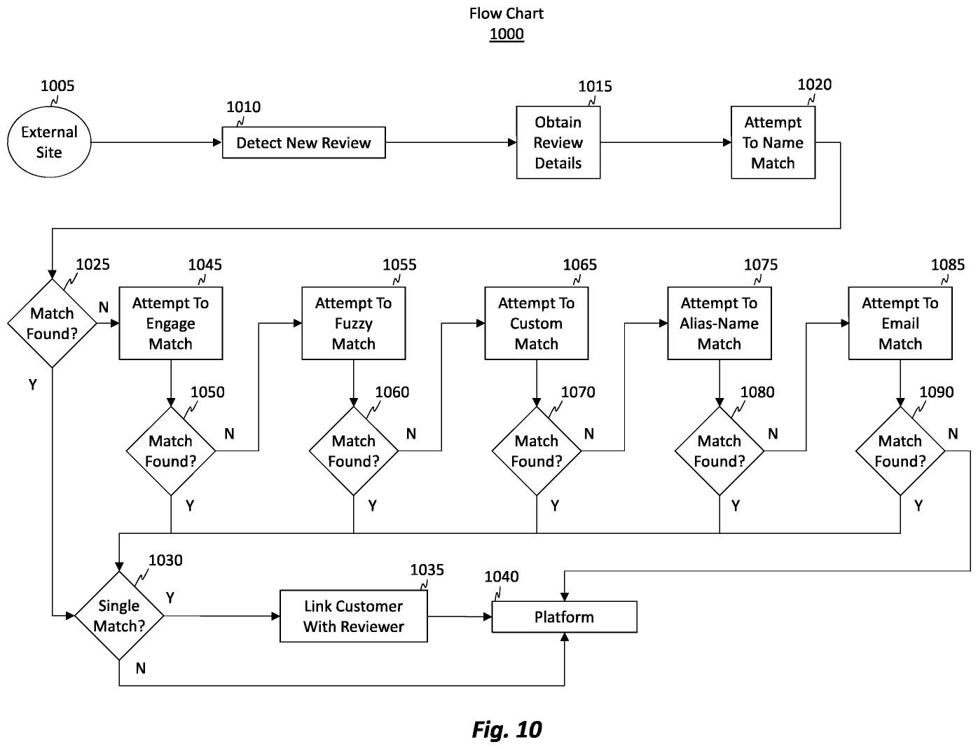

A challenge occurs when a “user” (in this context, a “user” is an individual who may not immediately be known to the SAAS cloud platform) provides feedback to a third-party platform that is distinct and independent relative to the SAAS cloud platform 105. Here, the user's identity may not be initially known. It is highly desirable for the business to learn of the user's identity for the reasons mentioned previously. The disclosed embodiments, therefore, are configured to be able to determine the identity of a user who has provided third-party feedback to a platform or entity that is distinct relative to the SAAS cloud platform 105. The remaining figures discuss various architectures, flow diagrams, and other supporting illustrations showing how the embodiments are able to determine the identity of a user who submitted third-party feedback. FIGS. 3 and 4 illustrate various techniques for acquiring the third-party feedback. FIGS. 5A and 5B illustrate various techniques for analyzing the third-party feedback to determine an identity of the user. FIGS. 6 through 9 illustrate an example methods, and FIG. 10 illustrates an example flowchart.

### Example Architectures for Acquiring Third-Party Feedback

Attention will now be directed to FIG. 3, which illustrates an example architecture 300 configured to determine an identity of a user who submitted third-party feedback. The architecture 300 can be a build-on to the architecture 100 of FIG. 1. For instance, the architecture 100 is shown as including a SAAS cloud platform 305 and a ML engine 310. The SAAS cloud platform 305 can be representative of the SAAS cloud platform 105 of FIG. 1, and the ML engine 310 can be representative of the ML engine 110.

In this scenario, the SAAS cloud platform 305 is managing a website list 315. This website list 315 is a list comprising any number of websites that a business entity may be affiliated with in any manner. For instance, a first website in the list may be a Google-based website, such as perhaps one that includes reviews or driving directions, for a particular business. A second website in the list may be a forum that publishes articles, one of which is about the business. A third website in the list may be a news website that has mentioned the business.

Here, a business entity can subscribe with the SAAS cloud platform 305 in order to use the SAAS cloud platform 305 to help improve the business's client relationships. To do so, the business entity can submit any number of websites that it is aware of that includes content related to the business entity. In some cases, the business entity can populate the website list 315. In some cases, the SAAS cloud platform 305 can populate the website list 315. In any event, each subscribed business entity will have its own respective website list 315 managed by the SAAS cloud platform 305.

In accordance with the disclosed principles, the SAAS cloud platform 305 is able to generate any number and/or any type of queries 320. The queries 320 are designed to extract user-provided information from the websites included in the website list 315. This user-provided information can be in the form of feedback. Additional information can be extracted as well, such as metadata associated with the feedback and/or other information associated with the feedback. The SAAS cloud platform 305 will analyze the feedback and will attempt to determine an identity of the user who submitted the feedback.

Different queries may be generated for different websites. For instance, FIG. 3 shows a first website 325, a second website 330, and a third website 335. These websites are included in the website list 315. Furthermore, each of these websites includes some information that is directed to or is related to a particular business entity that is subscribed with the SAAS cloud platform 305. Notably, the organization of these different websites may be different. Thus, the embodiments are able to customize queries based on the structure or organization of a website.

These different websites are affiliated with entities that are distinct and separate from the SAAS cloud platform 305. For instance, the website 325 may be associated with a third-party computing entity 340, such as perhaps Google, Yelp, or any other entity that is different from the SAAS cloud platform 305.

A first query can be tailored or customized based on the structure or organization of the website 325. A second query can be customized based on the structure or organization of the website 330. A third query can be customized based on the structure or organization of the website 335. These queries are designed to extract feedback from the various different websites as well as other information associated with the feedback, such as perhaps user identifying information, user location information, user profile information, user timing information, or even user image information. For instance, in response to executing a query against the content included in the website 325, a set of third-party feedback 345 is obtained from the website 325. This third-party feedback is representative of the feedback 200 of FIG. 2. Thus, the third-party feedback 345 can be obtained based on using a website list 315 to query various websites. Executing the query against the content can also produce other information, such as the identifying information, location information, and so on. Accordingly, in some cases, a list of websites can be maintained, and this list can be used to query those websites.

FIG. 4 shows another example architecture 400, which can be representative of the architectures mentioned thus far. Architecture 400 is shown as including a SAAS cloud platform 405 and an ML, engine 410, which can include an NLP engine 415 designed to determine a sentiment 420 from unstructured feedback.

The architecture 400 is designed to acquire feedback from sources that may not otherwise be listed in the website list 315 from FIG. 3. To do so, the SAAS cloud platform 405 can implement a web crawler 425. The web crawler 425 is a set of one or more bots that are designed to initially examine a base set of websites. From those websites, the bots identify other websites and URLs. The bots continually expand their searches and crawl to new websites. The bots are designed to identify key words or phrases that may be associated with the subscribed business entity, such as perhaps the name of the business or any other identifying information related to the business or perhaps even product or service information for the business. If such information is found, then the bot can tag the website as one that will be queried to potentially extract third-party feedback.

With regards to FIG. 4, the web crawler 425 is shown as crawling to the websites 430, 435, and 440. Website 430 was found to include information related to the subscribed business entity. As a result, the web crawler 425 raised a flag with regard to the website 430, where the flag indicates that the website 430 is to be queried to determine whether it includes third-party feedback related to the subscribed business entity. In this manner, various different mechanisms can be employed to identify third-party feedback. Once that third-party feedback is identified and obtained, then the SAAS cloud platform 405 can analyze it in an attempt to determine an identity of the user who provided the third-party feedback. FIGS. 5A and 5B illustrate various different analysis techniques to attempt to identify a user's identity.

### Techniques for Determining a User's Identity from Third-Party Feedback

As indicated above, FIGS. 5A and 5B illustrate various techniques 500 for analyzing third-party feedback, or perhaps information associated with the third-party feedback, to determine an identity of a user who submitted the third-party feedback. In particular, FIG. 5A shows feedback 505, which can be representative of the third-party feedback 345 from FIG. 3 or the feedback 445 from FIG. 4. A user 510 submitted the feedback 505 to a third-party platform, such as perhaps Google, Bing, Yelp, Facebook, Instagram, TikTok, or any other platform that is separate from the SAAS cloud platform described herein. In accordance with the disclosed principles, the SAAS cloud platform has acquired the feedback 505 as well as any information associated with the feedback 505 (e.g., perhaps metadata). The SAAS cloud platform analyzes the information to determine the user 510's identity.

A first technique included among the techniques 500 is a fuzzy logic-based technique that includes a spelling-based token match 515. With this logic, the SAAS cloud platform assigns a probability based on a success or failure to match a name that is associated with the feedback 505 (e.g., a user's name) and a name that is included in a database of names managed by the SAAS cloud platform (e.g., customer names). That is, the SAAS cloud platform can include a customer list for customers of the business entity. To be clear, SAAS cloud platform can include accounts or profiles for customers who engage with the business. Identifying information for these customers can be maintained. One object of the disclosed embodiments is to attempt to link a user's name who submitted feedback with an actual customers name, which is managed by the SAAS cloud platform. If a user's name is associated or attributed with the feedback 505, then the SAAS obtains that name and performs a lookup operation in its database to determine whether that name also exists in the customer database.

If there is a 100% match between the name associated with the feedback 505 and a name in the customer database, then there is a complete match, and the corresponding customer in the customer database can be attributed to the feedback 505. The feedback 505 can also be entered into the customer's account in the SAAS cloud platform. In some cases, a 100% match may not be required. In some cases, a threshold level of match (e.g., some threshold less than 100%) can be employed. Therefore, even if there is not a 100% match, some embodiments may still determine that a particular customer is the user who submitted feedback.

To facilitate these operations, the SAAS cloud platform identifies text associated with the feedback 505, where the text is determined as being a possible name for a user who submitted the feedback 505. The ML engine can be trained to recognize names based on text. The ML engine can be trained based on any language and can be trained to detect name patterns or words that are commonly used as names.

The text might be included in the feedback 505 itself, or perhaps the text might be appended to the feedback 505 or otherwise in proximity to the feedback 505 in the website. For instance, the website might include a field with the following text: “this product is amazing.” In another field, the website might include the following text: “submitted by Shane Brown.” In this manner, the query can examine not only a feedback field, but it can also examine surrounding or proximate areas in the website in an attempt to identify a name associated with the feedback. In some cases, the embodiments define a proximity threshold. For instance, the embodiments may configure the query to search website content that is within a threshold number of pixels relative to the feedback. In some cases, the query may be designed to generate a surrounding box around the feedback and then examine other website content that is within the threshold distance relative to the box.

The SAAS cloud platform is able to acquire the actual feedback (i.e. the text “this product is amazing”) as well as the supplementary text (e.g., the text “submitted by Shane Brown”). The SAAS cloud platform can analyze these various passages (perhaps using the ML engine) to determine what text might possibly correspond to a name. That text for the name is then extracted and analyzed.

Each word in the name text can be treated as a token. For instance, FIG. 5A shows a token 520. A different token can be attributed to each part of a user's potential name, as shown by the name(s) 525. To further illustrate, a first token can be assigned to the text “Shane” and a second token can be assigned to the text “Brown.”

The SAAS cloud platform also generates tokens for the names that are included in the customer database. Having generated these various different tokens, the SAAS cloud platform then performs a comparison operation between the different tokens in an attempt to find token matches. A “match” occurs when the text for a token for the user's potential name is within a threshold level of similarity as the text for a token for one of the names included in the customer database. The threshold level of similarity can be set to any threshold. In some cases, the threshold level of similarity may be set to a 100% level of similarity. In some cases, the threshold may be less than 100%.

Based on the number of matches (which is based on the threshold) for each token, a match percentage is calculated. To continue the above example, suppose the customer database had the following three names for customers: “Shane Doe,” “Bob Brown,” and “Shane Brown.” Here, there would be a 50% match between the tokens generated for “Shane Doe” and “Shane Brown,” there would be a 50% match between the tokens generated for “Bob Brown” and “Shane Brown,” and there would be a 100% match between the tokens generated for “Shane Brown” and “Shane Brown.” In some embodiments, the SAAS cloud platform refrains from considering a name prefix and/or suffix when generating tokens and when performing the comparison operation.

With the spelling-based token match 515 operation, the SAAS cloud platform compares the tokens in an attempt to find an exact match or at least a match that meets a defined threshold 530 or “match threshold.” If the match meets the threshold 530, then an identity 535 of the user can be determined because one of the customers listed in the customer database is likely to be the user who provided the feedback.

As another example, consider a scenario where a user's name (who submitted a review) is determined to be “John Smith, Jr.”, and the business using the SAAS cloud platform has a customer in its customer database named “John Hilton Smith.” Using the spelling-based token match 515 technique, the “Jr” is not considered for matching. On the user-name side, tokens are given for “John” and “Smith.” One the customer-name side, tokens are given for “John,” “Hilton,” and “Smith.”

Comparing the various tokens gives a match of 2 tokens out of 3 tokens (e.g., in this scenario, the maximum number of tokens is 3 since there are 3 words in the name). Consequently, an exact token match score of 66.6% is generated (based on 2 out of 3 exact matching tokens). With the spelling-based token match 515 technique, it is typically the case that the match threshold is set to 100%, meaning that all of the tokens are required to match with one another. In some embodiments, however, a lower threshold can be used, such as perhaps a threshold of at least a 90% match, an 80% match, a 70% match, a 60% match, or perhaps more than a 50% match. Typically, however, the spelling-based token match 515 operation is based on a 100% match requirement.

If the match threshold is not met, then the SAAS cloud platform can utilize an additional, or alternative, technique to attempt to determine the user's identity. That technique is the sound-based token match 540 technique illustrated in FIG. 5A.

With the sound-based token match 540 technique, the SAAS cloud platform considers the sound of the names being analyzed and compares those sounds to sounds of names in the business's customer database, which is managed by the SAAS cloud platform. For example, if the user's name is determined to be “John Smith,” that name is encoded using a phonetic algorithm 540A, such as perhaps a Soundex algorithm. The names in the business's customer database, which is managed by the SAAS cloud platform, are also encoded using the same phonetic algorithm. Encoding these names results in the generation of various sound-based tokens. For instance, a first set of sound-based tokens are generated for the user's supposed name (e.g., “John Brown”) and a second set of sound-based tokens are generated for the names in the customer database.

The SAAS cloud platform then compares the first set of sound-based tokens against the second set of sound-based tokens in an attempt to find a match. Suppose, for example, a customer listed in the customer database had the name “John Browne.” The sound-based tokens generated for “John Brown” will have the same sound encoding as the sound-based tokens generated for “John Browne.” Therefore, in this particular scenario, the SAAS cloud platform will determine that there is likely a match.

As mentioned above, in some cases, a match threshold can be implemented. If the level of similarity between the different sound-based tokens meets or exceeds the match threshold, then the SAAS cloud platform will determine that a match exists between the user's determined name and a customer that is included in the customer database. On the other hand, if the level of similarity between the different sound-based tokens does not meet the match threshold, then the SAAS cloud platform will determine that a match does not exist. That match threshold, as mentioned above, can be set to any threshold level of match or similarity (e.g., 100%, 95%, 90%, etc.).

As another example, suppose the user's determined name is “John Smith,” and further suppose a customer in the customer database had the name of “John Schmidt.” Sound-based tokens will be generated for these names. Suppose further that the level of phonetic similarity between the sound “Smith” and “Schmidt” was determined to be 94%. If the match threshold were set to a 95% match similarity requirement, then the SAAS cloud platform would determine that a sufficient level of match does not exist in this scenario.

The spelling-based token match 515 technique and the sound-based token match 540 technique are examples of so-called “fuzzy” logic operations. Such operations are considered “fuzzy” because these approaches perform computing operations based on a degree of similarity or a degree of truth rather than a strict Boolean logic (e.g., yes or no) approach.

Another technique for determining the identity of a user is referred to as a partial name match 545 technique. For instance, it may not always be possible to find a 100% match between a user's supposed name and an existing customer's name. If a match cannot be made using the fuzzy logic approach(es) described above, custom logic can then be applied. The partial name match 545 technique is an example of custom logic.

It is often the case that some review or rating sources (e.g., Google, Yelp, Bing, etc.) prefer not to show the full name of a customer. Such a scenario often creates difficulties for fuzzy match algorithms when attempting to identify matches. For instance, consider a scenario where the rating source listed the name of the reviewer/user as “John S.” instead of “John Smith.”

Using custom logic, a match can still be found using the partial name match 545 technique. With the partial name match 545 technique, the SAAS cloud platform generates tokens for each letter in the user's determined name and generates tokens for each letter in the customers' names in the customer database. The SAAS cloud platform further considers the ordering of those letters and tokens.

To illustrate, for the user's name “John S.,” the SAAS cloud platform will generate a first token for the letter “J,” a second token for the letter “o,” a third token for the letter “h,” a fourth token for the letter “n” and a fifth token for the letter “S.” The first four tokens will be characterized as being associated with a first name, and the fifth token will be characterized as being associated with a last name. This characterization can be performed by the ML engine. In some cases, the characterization can be performed based on the capitalization of the letters. Furthermore, the SAAS cloud platform will recognize that the letter “S” refers to the first letter in a customer's last name.

The SAAS cloud platform will also generate tokens for each letter for each of the customer names in the customer database. The SAAS cloud platform will then perform a comparison process to determine whether any of the token/name pairs in the customer database match the token/name pair of the user's name.

Suppose a first name in the customer database was “John Silvers” and a second name in the customer database was “John Smith.” Tokens will have been generated for the four letters forming the name “John.” Tokens will also have been generated for the letters “Silvers” and “Smith.”

The SAAS cloud platform will perform a comparison between the various tokens and determine that either one of “John Smith” and “John Silvers” could potentially be the user who submitted the feedback. Inasmuch as there are two potential candidates, the SAAS cloud platform can assign a 50% probability to each of these two customers as potentially being the user who submitted the review. When the probability is below a threshold level or when multiple candidates exist, the SAAS cloud platform can attempt to rely on supplemental information to further improve the determination.

With regard to “supplemental information,” an example will be helpful. In one scenario, the SAAS cloud platform may analyze the interaction history those two customers have had with the business entity. Suppose John Smith has not shopped at the business for a prolonged period of time, as determined by Smith's purchase history. Suppose John Silvers is a frequent visitor who shops at the business often. In this example scenario, the SAAS cloud platform may adjust the probabilities that were previously assigned because it may be determined that John Silvers, based on his frequency of shopping with the business, is more likely to be the user who left the review. As an example, the SAAS cloud platform may adjust the probabilities so that John Smith now has about a 25% likelihood of being the user who left the review while John Silvers now has about a 75% likelihood of being the user who left the review.

Further suppose that John Silvers has previously left feedback, but John Smith has never left feedback. Based on this additional, supplemental information, the SAAS cloud platform may further adjust the probabilities. Because John Silvers has left feedback, the SAAS cloud platform may increase his probability, such as perhaps to 85%, and John Smith will now have a probability of 15%.

Further suppose the feedback indicated that the user purchased a particular product and that the user very much liked the product. The SAAS cloud platform/service can review the customer database to determine what products customers have previously purchased. Suppose the SAAS cloud platform determined that John Silvers has previously purchased the product mentioned in the review (based on the customer's purchase history information), but John Smith has never purchased the product. Now, the SAAS cloud platform can further adjust the probabilities. As one example, John Silver's probability may now be 97% while John Smith's probability may now be 3%. If the match threshold was required to be 90%, then John Silver's probability exceeds that minimum threshold, and the SAAS cloud platform may determine that the user who left the review is John Silvers.

In this manner, the SAAS cloud platform can use supplemental information to help determine the identity of the user. The supplemental can include, but is not limited to, information relating to previous engagements a customer may have had, previous purchases the customer may have completed, or even frequency of contact with a business. The user's location data can also be used as supplemental information. In some cases, even the user's IP address can be used as supplemental information. In some cases, the timing with regard to when the user submitted the review can be used as supplemental information.

FIG. 5B illustrates various other techniques 500, one of which is a name-alias match 550 technique. The SAAS cloud platform can maintain a name-alias dictionary 550A comprising derivative names 545A for names. A derivative name can be a shortened version of a name, a nickname, or any other name derived from a base name. As an example, consider the name “Andrew.” One example of a derivative name for “Andrew” is the name “Andy.” Consider the name “Ashley.” One example of a derivative name for “Ashley” is “Ash.” Consider the name “Kaitlyn.” Derivatives names for “Kaitlyn” include “Kate,” “Katie,” “Kat” or perhaps “Cat.” Notice, it may be the case that the derivative name can be spelled quite differently from the base name, and the derivative name may even start with a different letter than the base name.

Suppose the SAAS cloud platform determined a name for a user who left a review, and suppose that name was “John Smith.” Examples of derivative names for “John Smith” can be “Jon Smith” or “Jonny Smith.” The name-alias dictionary 550A can include any number of different derivative names for the names of the customers included in the customer database.

The SAAS cloud platform can lookup derivative names for “John Smith” and attempt to find a match in the customer database. Suppose, for example, that the customer's name in the customer database is listed as “Jon Smith.” Despite the user's name being determined to be “John” and despite the customer database including “Jon,” the SAAS cloud platform can nevertheless find a match because “Jon” is a derivative form of “John.” The customer's account in the database can then be linked with the review because that user's/reviewer's identity has been determined.

Another example technique is referred to as the email match 555 technique. In some cases, customers might have very different social profile names than their actual name; however, in many cases, their email addresses will include at least a part of their actual names. The SAAS cloud platform is able to parse an email address in an attempt to determine whether the email address includes a part or perhaps even all of a user's name. As before, the ML engine can be employed to determine whether text in the email address might possibly correspond to a person's name.

The SAAS cloud platform can then compare that name to names in the customer database to determine the identity of the user who left the feedback. Accordingly, after the email is parse and a name is extracted, any of the techniques mentioned herein can be used to analyze that name.

In terms of parsing the email address, any type of machine learning can be performed to determine whether the email address includes a name. Additionally, any of the other techniques mentioned herein can also incorporate the use of machine learning. During the parsing process, the SAAS cloud platform can filter or remove special characters and/or numbers. As an example, suppose the following email address was linked or otherwise associated with a user review: “Slade.Webb.84@gmail.com”. Here, the special characters include periods (“.”), numbers (“84”), and the address sign (“@”). These characters can be filtered or removed such that no token will be associated with them. The domain name (e.g., “gmail.com”) can also be ignored. After filtering the special characters, “Slade” and “Webb” remain. The SAAS cloud platform can determine, perhaps using machine learning, that these two words can possibly be a name. As a result, the SAAS cloud platform can then perform any of the name matching techniques described herein.

In some cases, the user's email address might include a person's username for some other account. For instance, suppose the email address was “Dragon_Slayer@gmail.com”. Further suppose the user had a social media account, and that user's username was “Dragon_Slayer.” The SAAS cloud platform can be configured to use that text as parameters to query other platforms, including social media platforms, in an attempt to identify the user. To continue the example, suppose the user had an Instagram account with the username “Dragon_Slayer,” and the Instagram account did include the user's actual name. Here, the SAAS cloud platform can use the text to query Instagram to obtain the user's actual name. Thus, the SAAS cloud platform can optionally use information from one source (e.g., the feedback) to query a different source (e.g., a different platform) that is different from the SAAS cloud platform.

Another example technique is a timing match 560 technique. With this technique, the SAAS cloud platform attempts to find customers who engaged with the business within a range of time relative to the time when the review was submitted. Based on the determined engagement, the SAAS can assign probabilities to customer names, where those probabilities indicate a likelihood that each customer had with regard to providing the review. If a product or service can be identified from the feedback, then that information can also be used to help narrow the search in the customer database.

Another technique is an image match 565 technique. In some cases, platforms can display an avatar or an image of the user who submitted a review. The SAAS cloud platform is able to obtain this image and can perform an image comparison. If the customer database has an image of the customers, then the comparison can be performed using those images. In some cases, the SAAS cloud platform can query or consult social media platforms, such as Facebook, Instagram, LinkedIn, and so on. It is typically the case that those platforms include an image of their users as well as their names. The SAAS cloud platform can compare the image associated with the review/feedback with images provided by the social media platforms. If a match is found (e.g., at least up to a threshold level of match), then the SAAS cloud platform can identify the name that is associated with the image of the social media platform. Once that name is determined, then the SAAS cloud platform can perform any of the name matching techniques described herein to determine whether the user is a customer who has an account with the SAAS cloud platform.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Attention will now be directed to FIGS. 6, 7, 8, and 9, which illustrate various flowcharts of example methods that can be performed to determine the identity of a user who submitted third-party feedback.

FIG. 6 shows a flowchart of a method 600, which is implemented by the SAAS cloud platform described herein, for using fuzzy logic to determine an identity of a user who provided structured and/or unstructured third-party feedback, where the third-party feedback is feedback that was provided to a third-party computing entity that is distinct relative to the SAAS cloud platform.

Method 600 includes an act (act 605) of maintaining a list of websites for third-party computing entities that are distinct relative to the SAAS cloud platform. For instance, FIG. 3 showed how the SAAS cloud platform 305 is able to maintain a website list 315.

Act 610 includes querying a first website that is included in the list of websites. The query is designed to extract third-party feedback that a user provided to the first website. The third-party feedback is directed toward an entity with whom the user previously engaged. The query is further designed to extract other supplemental information that is associated with the feedback. FIG. 3 showed how a query was executed against the website 325 and how third-party feedback 345 was obtained.

Act 615 includes receiving a result as a consequence of executing the query. The result includes the third-party feedback, which was extracted from content hosted by the first website. The result can further include full or perhaps incomplete identifying information, such as name or partial name information. In some cases, the result can include supplemental information, such as perhaps a name, username, alias, timing information, product information, location information, image information, and so on.

In some implementations, the third-party feedback includes unstructured feedback. Optionally, the embodiments can use natural language processing to provide structure to the unstructured feedback and to determine a sentiment for the unstructured feedback. The resulting structured feedback can then be linked to the user who provided the feedback, and an identity of that user can be determined.

Act 620 includes identifying, from the result, a name associated with the third-party feedback. The name can be a full name (e.g., a full first name and a full last name), a partial name (e.g., perhaps a full or partial first name and a full or partial last name), or even a derivative name. Act 620 is shown as being surrounded by a dashed box because this act is included in some, but not all, of the subsequent methods that will be discussed in the later figures.

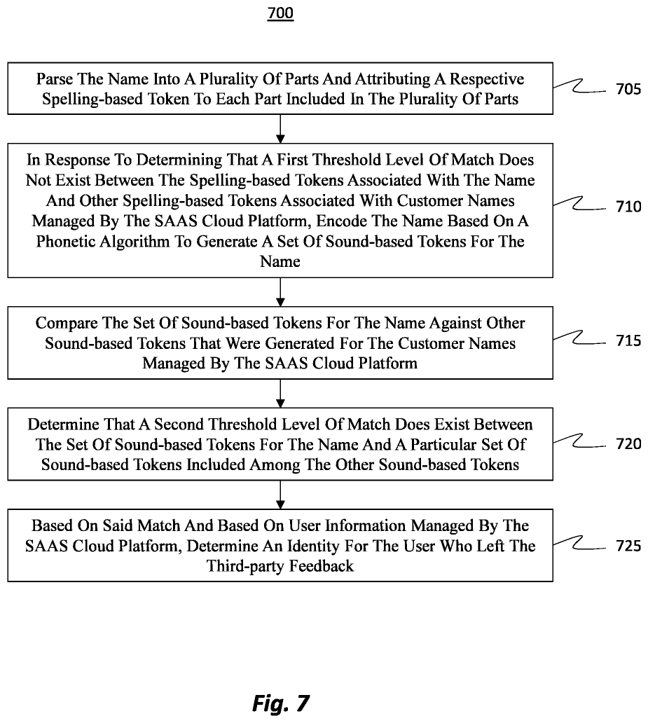

Method 600 is continued in FIG. 7 as method 700. Act 705 includes parsing the name into a plurality of parts and attributing a respective spelling-based token to each part included in the plurality of parts. For instance, if the name includes a first name portion and a last name portion, then tokens are attributed to each of those portions. In some implementations, the process of parsing the name into the plurality of parts includes parsing the name into one or more of a first name, a middle name, and a last name. Optionally, name prefixes and name suffixes can be ignored.

In response to determining that a first threshold level of match does not exist between the spelling-based tokens associated with the name and other spelling-based tokens associated with customer names managed by the SAAS cloud platform (e.g., by performing the spelling-based token match 515 technique described with respect to FIG. 5A), act 710 includes encoding the name based on a phonetic algorithm to generate a set of sound-based tokens for the name. For instance, the Soundex phonetic algorithm can be used. Such an operation is included in the sound-based token match 540 technique mentioned in FIG. 5A. In some cases, the first threshold level of match is a 100% threshold. In some cases, the first threshold level of match can be lower than 100%.

Act 715 includes comparing the set of sound-based tokens for the name against other sound-based tokens that were generated for the customer names managed by the SAAS cloud platform.

Act 720 includes determining that a second threshold level of match does exist between the set of sound-based tokens for the name and a particular set of sound-based tokens included among the other sound-based tokens. In some cases, the second threshold level of match is at least a 50% threshold. It may be the case that a first name that is determined for the name has multiple spellings (e.g., “Jon” or “John”). Here, any sound-based tokens that are generated for the multiple spellings will have the same sound despite the words being spelled differently.

Based on the match and based on user information managed by the SAAS cloud platform, act 725 includes determining an identity for the user who left the third-party feedback. That is, the SAAS cloud platform manages a customer database that includes identifying information for customers, The SAAS cloud platform is able to make correlations between the customers in the database and the user's name in order to determine the user's identity. If a name in the customer database matches the user's name, then it is likely the case that the customer was the one who submitted the feedback. Consequently, the feedback can be attributed to that customer, and the user's identity is thus the identity of the customer (i.e. the user and the customer are the same individual).

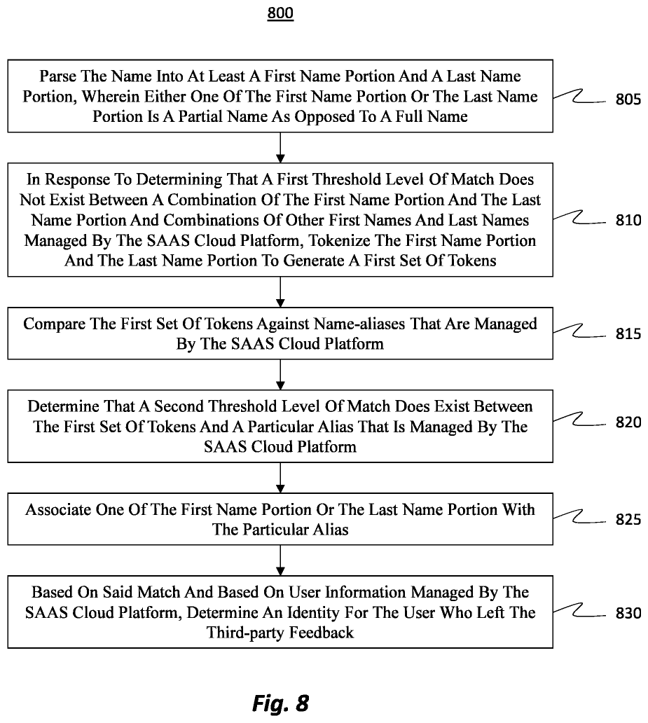

FIG. 8 shows an example method 800, which is also implemented by the SAAS cloud platform and which is performed to determine an identity of a user who provided structured and/or unstructured third-party feedback, where the third-party feedback is feedback that was provided to a third-party computing entity that is distinct relative to the SAAS cloud platform.

Method 800 includes acts 605, 610, 615, and 620 from FIG. 6.

After act 620 from FIG. 6 is performed, method 800 includes an act (act 805) of parsing the name into at least a first name portion and a last name portion. In this scenario, either one of the first name portion or the last name portion is a partial name as opposed to a full name. As an example, suppose the name is “John S.” Here, the first name is a full name (e.g., “John”) but the last name is a partial name (e.g., “S.”).

In response to determining that a first threshold level of match does not exist between a combination of the first name portion and the last name portion and combinations of other first names and last names managed by the SAAS cloud platform (e.g., the partial name match 545 technique may have been performed, but the resulting threshold may not have been satisfied), act 810 includes tokenizing the first name portion and the last name portion to generate a first set of tokens. In some implementations, tokens are generated for the first name portion and the last name portion. The process of determining that the first threshold level of match does not exist can be based on an analysis of the tokens for the first name portion and the last name portion.

Act 815 includes comparing the first set of tokens against name-aliases that are managed by the SAAS cloud platform. Here, the name-alias match 550 technique is being started.

Act 820 includes determining that a second threshold level of match does exist between the first set of tokens and a particular alias that is managed by the SAAS cloud platform. The alias, which is managed by the SAAS cloud platform, can be included in a name-alias dictionary.

For instance, suppose the feedback had the following name associated with it: “Andrew.” Suppose further that the SAAS cloud platform consults a name-alias dictionary and determines than one alias for “Andrew” is “Andy.” Suppose further that a customer database, which is managed by the SAAS cloud platform, included a customer whose name was listed as “Andy.” Here, the SAAS cloud platform can find a match using the alias, as mentioned above, even though there is a difference between the user's name and the name in the customer database.

Act 825 includes associating one of the first name portion or the last name portion with the particular alias. For instance, the SAAS cloud platform can update the identified customer's profile to include not only the name “Andy” but also the name “Andrew.”

In some cases, the last name portion is the partial name, and the first name portion is associated with the alias. In some cases, the first name portion is the partial name, and the last name portion is associated with the alias. In some implementations, the alias is a derivative version of the first name portion or of the last name portion (e.g., “Cat” is a derivative form of “Caitlyn”). The alias can be one of a derivative version of the first name portion or a shortened version (e.g., “Ash” is a shortened form of “Ashley”) of the first name portion.

Optionally, the process of associating the one of the first name portion or the last name portion with the particular alias includes replacing the one of the first name portion or the last name portion with the particular alias in the customer database. Optionally, instead of replacing, the embodiments can append or include the additional name with the existing name in the customer database.

Based on the match and based on user information managed by the SAAS cloud platform, act 830 includes determining an identity for the user who left the third-party feedback. That is, because there is a match between the user and a customer in the customer database, the embodiments can use attribute the identity of the customer to the user.

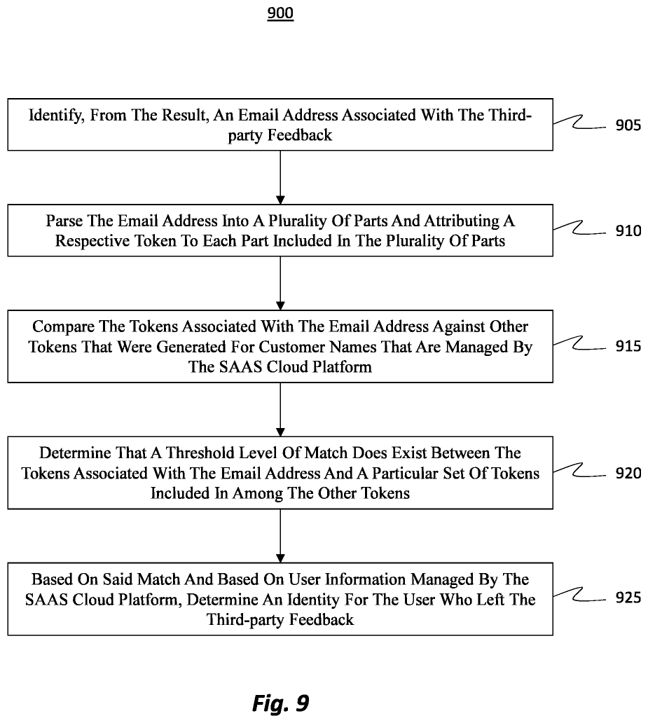

FIG. 9 shows a flowchart of an example method 900 that can also be implemented by the SAAS cloud platform. Method 900 is configured to determine an identity of a user who provided structured and/or unstructured third-party feedback, where the third-party feedback is feedback that was provided to a third-party computing entity that is distinct relative to the SAAS cloud platform. Acts 605, 610, and 615 from FIG. 6 can be included in method 900.

Act 905 includes identifying, from the result, an email address associated with the third-party feedback.

Act 910 includes parsing the email address into a plurality of parts and attributing a respective token to each part. For instance, as a part of parsing the email address, the SAAS cloud platform may discover a name included as a part (or perhaps username) of the email address, such that the email match 555 technique from FIG. 5B can be performed. To illustrate, the email address may comprise a first name and/or a last (or second) name of the user. The names can be full or partial names. Machine learning can be employed to determine what set of letters corresponds to a full or partial first name and what set of letters corresponds to a full or partial last name. As an example, consider the following email address: “SBrown@gmail.com”. Here, the ML engine can determine that the “S” likely corresponds to the user's first name and “Brown” likely corresponds to the user's last name.

The process of parsing the email address into the plurality of parts can include extracting the first name and the last/second name (or portions thereof) and ignoring special characters and an email domain. Optionally, the first or last name can be a derivative version of an actual first name of the user. As another option, the first or last name can be a shortened version or abbreviated version of an actual first name of the user. Tokens can be attributed to the discovered name or names.

Act 915 includes comparing the tokens associated with the email address against other tokens that were generated for customer names that are managed by the SAAS cloud platform.

Act 920 includes determining that a threshold level of match does exist between the tokens associated with the email address and a particular set of tokens included in among the other tokens.

Based on the match and based on user information managed by the SAAS cloud platform, act 925 includes determining an identity for the user who left the third-party feedback.

### Example Flow Chart

FIG. 10 shows an example flow chart 1000 that can generally be followed by the disclosed SAAS cloud platform to determine the identity of a user who submitted feedback. Although the various block diagrams are illustrated as being connected to one another, the disclosed principles are flexible and can be performed in different orders than the one that is illustrated. In some cases, various timing or sequence requirements can optionally be imposed. Thus, in some cases, the embodiments perform the disclosed operations in the manner illustrated, one after the other. In some cases, the embodiments perform the disclosed operations in different orders.

Initially, the SAAS cloud platform identifies 1005 an external website that is affiliated or associated with a business entity. The website may be included in a list of websites managed by the SAAS cloud platform. In some cases, the SAAS cloud platform includes a web crawling bot that discovered the website. In any event, the SAAS cloud platform detects 1010 a new review that has been left by a user who frequented that website.

The SAAS cloud platform obtains 1015 details about the review. The details can include the substance of the review itself and/or details about who left the review. The details can include timing information, location information (e.g., where the user was located when the user left the review), or perhaps even product information if the review was directed to a product. The details can include information about an employee if the review was directed to an employee. The details can include information about a store if the review was directed to a store. Indeed, any type of data and/or metadata can be detected.

Based on the acquired details, the SAAS cloud platform attempts 1020 to analyze a name that is associated with the review to determine whether that name matches with any names included in a customer database managed by the SAAS cloud platform. For instance, it may be the case that the user's full name is provided, and the SAAS cloud platform can use that full information to consult a customer database to see if the user is a customer.

If a match is found at 1025, then the SAAS cloud platform will perform a determination 1030 as to whether there is only a single match. If a single match exists and no other matches exist, the SAAS cloud platform will link 1035 the identified customer with the review and will associate the customer's identity with the identity of the user who submitted the review. The flow chart 1000 can then cause the SAAS cloud platform 1040 to again monitor the websites.

If a match was not found at 1025, then the SAAS cloud platform can optionally perform an operation 1045 based on timing, such as by implementing the timing match 560 technique. Here, the SAAS cloud platform determines a time when the review was submitted and attempts to link or associate that time with timing information included in customer profiles in the customer database. It may be the case that the customer database includes event information as to when a customer interacted or perhaps purchased an item. The SAAS cloud service can infer a correlation between the user who submitted the review and a customer based on the proximity between the time the user submitted the review and a time when a customer engaged with the business in some manner. In some cases, the engagement can be with an employee of the business, and there may be a log of such an event. The SAAS cloud platform can optionally query that log as well in an attempt to make correlations.

At 1050, the SAAS cloud platform attempts to find a match. If a match is found, then the SAAS follows the “yes” path to the determination 1030 of whether this is a single match. If no match is found, the SAAS cloud platform can then attempt 1055 to perform a fuzzy logic match by performing one or both of the spelling-based token match 515 technique or the sound-based token match 540 technique from FIG. 5A.

At 1060, the SAAS cloud platform determines whether a match exists. If one does, then the “yes” path to the determination 1030 is followed.

If no match is found, the SAAS cloud platform can then attempt 1065 to perform a custom logic match by performing the partial name match 545 technique from FIG. 5A. At 1070, the SAAS cloud platform determines whether a match exists. If one does, then the “yes” path to the determination 1030 is followed.

If no match is found, the SAAS cloud platform can then attempt 1075 to perform an alias-name match by performing the name-alias match 550 technique from FIG. 5B. At 1080, the SAAS cloud platform determines whether a match exists. If one does, then the “yes” path to the determination 1030 is followed.

If no match is found, the SAAS cloud platform can then attempt 1085 to perform an email match by performing the email match 555 technique from FIG. 5B. At 1090, the SAAS cloud platform determines whether a match exists. If one does, then the “yes” path to the determination 1030 is followed.

If no match is found, an administrator can be alerted in an attempt to make an analysis and to perform a manual correlation or association via the platform 1040. As mentioned previously, these various attempts or operations can be performed in various other orders. For instance, the embodiments may first attempt to perform a spelling-based token match technique, then an email match technique, then a sound-based token match technique, then a custom match technique, then a timing based match technique. Indeed, other orders can be used as well.

In addition to determining the identity of the user, some embodiments can determine the identity of an employee who may have engaged with the user. For instance, it may be the case that a particular employee engaged with the user, and the user left positive or negative feedback regarding that employee. The embodiments can maintain an employee database listing the names of the employees and optionally their work schedules. Using the same principles as before (but now consulting the employee database instead of the customer database), the embodiments can attempt to determine the identity of the employee. Additional training or perhaps an award can be provided to the employee based on the interaction the employee had with the user.

Accordingly, the disclosed embodiments are beneficially configured to determine an identity of a user who submitted feedback. After the identity is determined, the feedback can then be attributed to a customer having that identity. The embodiments can attempt to rehabilitate the relationship if it has soured or can attempt to have the customer act as an advocate by sending referrals. By performing the disclosed operations, business can be greatly benefitted by identifying actual individuals who are submitting feedback.

Further benefits can be derived because the embodiments can also attempt to determine whether a bot is maliciously submitting feedback or whether an actual human is submitting feedback. If a bot is submitting feedback, then actions can be taken to remove the bot and/or remove the feedback. The review platform where the bot submitted the feedback can be notified by the SAAS cloud platform in order to cause the bot to be blocked or removed. Thus, improvements to computer security and data integrity can be achieved by following the disclosed principles.

### Example Computer/Computer Systems

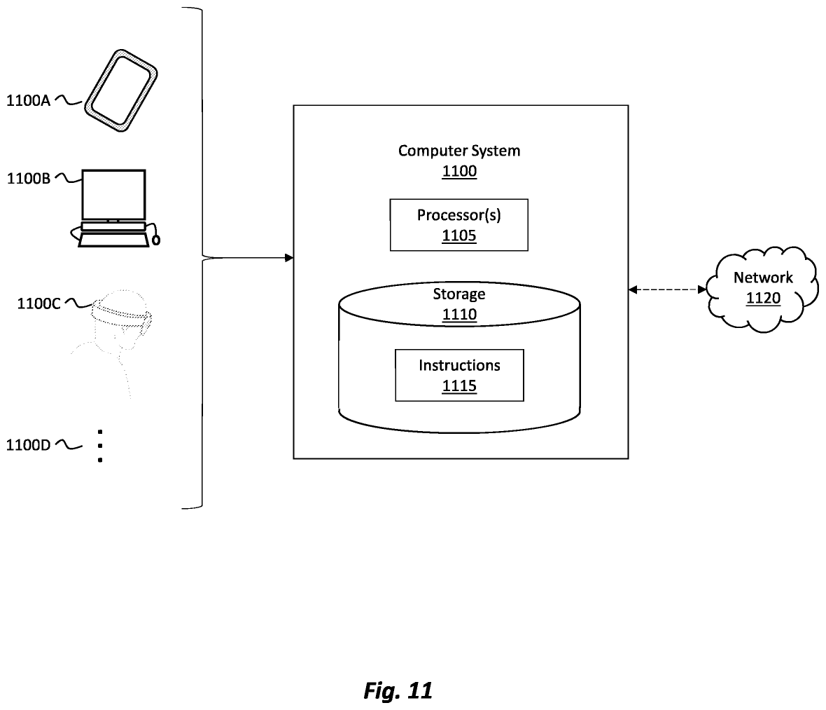

Attention will now be directed to FIG. 11 which illustrates an example computer system 1100 that may include and/or be used to perform any of the operations described herein, including the disclosed methods. For instance, the SAAS cloud platform can be implemented using the computer system 1100.

Computer system 1100 may take various different forms. For example, computer system 1100 may be embodied as a tablet 1100A, a desktop or a laptop 11001B, a wearable device 1100C, a mobile device, or any other standalone device as represented by the ellipsis 11001D. Computer system 1100 may also be a distributed system that includes one or more connected computing components/devices that are in communication with computer system 1100.

In its most basic configuration, computer system 1100 includes various different components. FIG. 11 shows that computer system 1100 includes one or more processor(s) 1105 (aka a “hardware processing unit”) and storage 1110.

Regarding the processor(s) 1105, it will be appreciated that the functionality described herein can be performed, at least in part, by one or more hardware logic components (e.g., the processor(s) 1105). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “engine,” or “platform” can refer to hardware processing units or to software objects, routines, or methods that may be executed on computer system 1100. The different components, modules, engines, and services described herein may be implemented as objects or processors that execute on computer system 1100 (e.g. as separate threads).

Storage 1110 may be physical system memory, which may be volatile, non-volatile, or some combination of the two. The term “memory” may also be used herein to refer to non-volatile mass storage such as physical storage media. If computer system 1100 is distributed, the processing, memory, and/or storage capability may be distributed as well.

Storage 1110 is shown as including executable instructions 1115. The executable instructions 1115 represent instructions that are executable by the processor(s) 1105 of computer system 1100 to perform the disclosed operations, such as those described in the various methods.

The disclosed embodiments may comprise or utilize a special-purpose or general-purpose computer including computer hardware, such as, for example, one or more processors (such as processor(s) 1105) and system memory (such as storage 1110), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1100 may also be connected (via a wired or wireless connection) to external sensors (e.g., one or more remote cameras) or devices via a network 1120. For example, computer system 1100 can communicate with any number devices or cloud services to obtain or process data. In some cases, network 1120 may itself be a cloud network. Furthermore, computer system 1100 may also be connected through one or more wired or wireless networks to remote/separate computer systems(s) that are configured to perform any of the processing described with regard to computer system 1100.

A “network,” like network 1120, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1100 will include one or more communication channels that are used to communicate with the network 1120. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, which is implemented by a software as a service (SAAS) cloud platform, for using fuzzy logic to determine an identity of a user who provided structured and/or unstructured third-party feedback, where the third-party feedback is feedback that was provided to a third-party computing entity that is distinct relative to the SAAS cloud platform, said method comprising:
maintaining a list of websites for third-party computing entities that are distinct relative to the SAAS cloud platform;
querying a first website that is included in the list of websites, wherein the query is designed to extract third-party feedback that a user provided to the first website, and wherein the third-party feedback is directed toward an entity with whom the user previously engaged;
receiving a result as a consequence of executing the query, wherein the result includes the third-party feedback, which was extracted from content hosted by the first website;
identifying, from the result, a name associated with the third-party feedback;
parsing the name into a plurality of parts and attributing a respective spelling-based token to each part included in the plurality of parts;
in response to determining that a first threshold level of match does not exist between the spelling-based tokens associated with the name and other spelling-based tokens associated with customer names managed by the SAAS cloud platform, encoding the name based on a phonetic algorithm to generate a set of sound-based tokens for the name;
comparing the set of sound-based tokens for the name against other sound-based tokens that were generated for the customer names managed by the SAAS cloud platform;
determining that a second threshold level of match does exist between the set of sound-based tokens for the name and a particular set of sound-based tokens included among the other sound-based tokens; and
based on said match and based on user information managed by the SAAS cloud platform, determining an identity for the user who left the third-party feedback.

2. The method of claim 1, wherein the phonetic algorithm is a Soundex phonetic algorithm.

3. The method of claim 1, wherein the first threshold level of match is a 100% threshold.

4. The method of claim 1, wherein the second threshold level of match is at least a 50% threshold.

5. The method of claim 1, wherein parsing the name into the plurality of parts includes parsing the name into one or more of a first name, a middle name, and a last name, and wherein name prefixes and name suffixes are ignored.

6. The method of claim 1, wherein a first name that is determined for the name has multiple spellings, and wherein any sound-based tokens that are generated for the multiple spellings have a same sound.

7. The method of claim 1, wherein the third-party feedback includes unstructured feedback, and wherein the method further includes:
using natural language processing to provide structure to the unstructured feedback and to determine a sentiment for the unstructured feedback.

8. A method, which is implemented by a software as a service (SAAS) cloud platform, for determining an identity of a user who provided structured and/or unstructured third-party feedback, where the third-party feedback is feedback that was provided to a third-party computing entity that is distinct relative to the SAAS cloud platform, said method comprising:
maintaining a list of websites for third-party computing entities that are distinct relative to the SAAS cloud platform;
querying a first website that is included in the list of websites, wherein the query is designed to extract third-party feedback that a user provided to the first website, and wherein the third-party feedback is directed toward an entity with whom the user previously engaged;
receiving a result as a consequence of executing the query, wherein the result includes the third-party feedback, which was extracted from content hosted by the first website;
identifying, from the result, a name associated with the third-party feedback;
parsing the name into at least a first name portion and a last name portion, wherein either one of the first name portion or the last name portion is a partial name as opposed to a full name;
in response to determining that a first threshold level of match does not exist between a combination of the first name portion and the last name portion and combinations of other first names and last names managed by the SAAS cloud platform, tokenizing the first name portion and the last name portion to generate a first set of tokens;
comparing the first set of tokens against name-aliases that are managed by the SAAS cloud platform;
determining that a second threshold level of match does exist between the first set of tokens and a particular alias that is managed by the SAAS cloud platform;
associating one of the first name portion or the last name portion with the particular alias; and
based on said match and based on user information managed by the SAAS cloud platform, determining an identity for the user who left the third-party feedback.

9. The method of claim 8, wherein the last name portion is the partial name, and wherein the first name portion is associated with the alias.

10. The method of claim 9, wherein the alias is a derivative version of the first name portion.

11. The method of claim 8, wherein associating the one of the first name portion or the last name portion with the particular alias includes replacing the one of the first name portion or the last name portion with the particular alias.

12. The method of claim 8, wherein the last name portion is the partial name, wherein the first name portion is associated with the alias, and wherein the alias is one of a derivative version of the first name portion or a shortened version of the first name portion.

13. The method of claim 8, wherein tokens are generated for the first name portion and the last name portion, and wherein determining that the first threshold level of match does not exist is based on an analysis of the tokens for the first name portion and the last name portion.

14. The method of claim 8, wherein the alias, which is managed by the SAAS cloud platform, is included in a name-alias dictionary.

15. A method, which is implemented by a software as a service (SAAS) cloud platform, for determining an identity of a user who provided structured and/or unstructured third-party feedback, where the third-party feedback is feedback that was provided to a third-party computing entity that is distinct relative to the SAAS cloud platform, said method comprising:
maintaining a list of websites for third-party computing entities that are distinct relative to the SAAS cloud platform;
querying a first website that is included in the list of websites, wherein the query is designed to extract third-party feedback that a user provided to the first website, and wherein the third-party feedback is directed toward an entity with whom the user previously engaged;
receiving a result as a consequence of executing the query, wherein the result includes the third-party feedback, which was extracted from content hosted by the first website;
identifying, from the result, an email address associated with the third-party feedback;
parsing the email address into a plurality of parts and attributing a respective token to each part included in the plurality of parts;
comparing the tokens associated with the email address against other tokens that were generated for customer names that are managed by the SAAS cloud platform;
determining that a threshold level of match does exist between the tokens associated with the email address and a particular set of tokens included in among the other tokens; and
based on said match and based on user information managed by the SAAS cloud platform, determining an identity for the user who left the third-party feedback.

16. The method of claim 15, wherein the email address comprises a first name of the user.

17. The method of claim 16, wherein the email address comprises a last name of the user.

18. The method of claim 17, wherein parsing the email address into the plurality of parts includes extracting the first name and the last name and ignoring special characters and an email domain.

19. The method of claim 16, wherein the first name is a derivative version of an actual first name of the user.

20. The method of claim 16, wherein the first name is a shortened version of an actual first name of the user.
